(19) United States
(12) Patent Application Publication
(10) Pub. No.: US 2015/0091836 A1
(43) Pub. Date: Apr. 2, 2015

(54) TOUCH CONTROL INPUT METHOD AND SYSTEM, COMPUTER STORAGE MEDIUM

(71) Applicant: TENCENT TECHNOLOGY (SHENZHEN) COMPANY LIMITED, Shenzhen City (CN)

(72) Inventors: Xianzhi Li, Shenzhen City (CN); Yong Fan, Shenzhen City (CN); Lei Zhou, Shenzhen City (CN); Xun Wang, Shenzhen City (CN); Jun Zhang, Shenzhen City (CN); Junhui Qin, Shenzhen City (CN)

(21) Appl. No.: 14/566,214

(22) Filed: Dec. 10, 2014

Related U.S. Application Data
(63) Continuation of application No. PCT/CN2013/076683, filed on Jun. 4, 2013.

(30) Foreign Application Priority Data
Jun. 12, 2012 (CN) 201210192858.3

(51) Int. Cl. G06F 3/0488

(52) U.S. Cl. CPC G06F 3/04886
USPC 345/173

(57) ABSTRACT

A touch control input method includes the steps: displaying an application program interface; configuring multiple touch areas for the application program interface; determining one or more touch areas with a higher probability of touch control by predicting a next input after an input according to a rule of an input operation; dynamically enlarging the one or more touch areas. Besides, a corresponding system and a non-transitory computer storage medium are provided. In the method, system, and non-transitory computer storage medium, a touch control area with a higher or highest probability of user clicking is found, and an area of the touch area is enlarged, the user can perform touching at one time to complete a more accurate touch action, thereby reducing user operation steps and omitting a step of partial enlargement. Therefore, the user experience is improved, and system operation costs are reduced.

### CROSS-REFERENCE TO RELATED APPLICATIONS

The present application is a continuation application of International Application No. PCT/CN2013/076683, filed Jun. 4, 2013, which itself claims the priority to Chinese application No. 201210192858.3 filed Jun. 12, 2012, which are incorporated herein by reference in their entireties.

### TECHNICAL FIELD

The present disclosure relates to touch technologies, and more particularly relates to a touch control input method and system, computer storage medium based on operation on a touch screen.

### BACKGROUND

Recently, applications of the mobile phone and tablet computer are increased greatly; touch screens become mainstream display panels employed by the smart phone and the tablet computer. Various PC softwares are installed to the mobile phone. User operates article such as mobile phone, and tablet computer by touching the touch screen with fingers. However, a touch area of the mobile phone is relative small, while the finger is relative large, and there are a mass of touch elements to be touched. The touch area for each touch element is relatively small, and the distance between the elements is much small. It is difficult for the user to accurately touch the desired touch area corresponding to a touch element, thus mis-operation may occur easily.

In one method, when user touches a position for the first time, the position and the interface of a preset area around the position are enlarged, and the touch area in the enlarged interface is enlarged proportionally. The user can touch on the enlarged partial interface accurately for the second time to accomplish a more accurate touch-control.

However, during the method, twice touches are required to just accomplish one touch-control; it is inconvenience for the user. Further, enlarging process is needed for every touch-control, cost for interaction is thereby increased, and it is power consuming. Only a part of the interface is shown after the enlargement, the confirmation of the original position to be touched can only rely on user's memory, therefore, an input mistake occurs easily and the burden of the user's memory is increased. Moreover, the three problems will result in a poor user experience.

### SUMMARY

Accordingly, it is necessary to provide a touch input method, a system, and a computer storage medium computer storage medium which could accomplish a touch operation by once touch and is easy to operate.

A touch control input method includes:

displaying an application program interface;

configuring a plurality of preset touch areas for the application program interface; determining one or more touch areas with a higher touch probability by predicting a next input after an input according to a rule of an input operation; and

dynamically enlarging the one or more touch areas with the higher touch probability.

In an embodiment, the dynamically enlarging includes:

enlarging before an input; and

restoring a default configuration after completing the input.

In an embodiment, the dynamically enlarging includes:

enlarging before an input; and

recalculating the touch probability for each touch area after completing the input.

In an embodiment, the method further includes:

shrinking an area of a touch area adjacent to an enlarged touch area, correspondingly.

In an embodiment, the determining one or more touch areas with a higher touch probability by predicting a next input after an input according to a rule of an input operation includes:

responding to a user touch action and acquiring a plurality of touch areas touched by the user touch action;

determining one or more touch areas with a higher touch probability of a user from the plurality of touch areas touched by the user touch action by predicting a next input after an input according to a rule of an input operation;

dynamically enlarging the one or more touch areas with the higher touch probability of the user; and

determining a touch area touched by the user among the one or more touch areas enlarged within a touch range of the user touch action.

A touch operation system includes one or more processors; and memory having instructions stored thereon, the instructions, when executed by the one or more processors, cause the processors to perform operations comprising:

displaying an application program interface;

configuring a plurality of preset touch areas for the application program interface;

determining one or more touch areas with a higher touch probability by predicting a next input after an input according to a rule of an input operation; and

dynamically enlarging the one or more touch areas with the higher touch probability of the user.

In an embodiment, the dynamically enlarging includes enlarging before an input; and

restoring a default configuration after completing the input.

In an embodiment, the dynamically enlarging includes enlarging before an input; and

recalculating the touch probability for each touch area after completing the input.

In an embodiment, the memory further includes instructions, which, when executed by the one or more processors, cause the processors to perform operations including:

displaying an application program interface;

configuring a plurality of preset touch areas for the application program interface;

responding to a user touch action and acquire a plurality of touch areas touched by the user touch action;

determining one or more touch areas with a higher touch probability of a user from the plurality of touch areas touched by the user touch action by predicting a next input after an input according to a rule of an input operation;

dynamically enlarging the one or more touch areas with the higher touch probability of the user; and

determining a touch area touched by the user among the one or more touch areas enlarged within a touch range of the user touch action.

In an embodiment, the dynamically enlarging includes enlarging before an input.

A non-transitory computer storage medium for storing a computer-executable instruction, the computer-executable instruction is configured to execute a touch control input method, the method includes:

displaying an application program interface;

configuring a plurality of preset touch areas for the application program interface; determining one or more touch areas with a higher touch probability by predicting a next input after an input according to a rule of an input operation; and

dynamically enlarging the one or more touch areas with the higher touch probability.

In an embodiment, the dynamically enlarging includes enlarging before an input; and

restoring a default configuration after completing the input.

In an embodiment, the dynamically enlarging includes enlarging before an input; and

recalculating the touch probability for each touch area after completing the input.

In an embodiment, the method further includes:

correspondingly shrinking an area of a touch area adjacent to an enlarged touch area.

In an embodiment, the determining one or more touch areas with a higher touch probability by predicting a next input after an input according to a rule of an input operation includes:

responding to a user touch action and acquiring a plurality of touch areas touched by the user touch action;

determining one or more touch areas with a higher touch probability of a user from the plurality of touch areas touched by the user touch action according to rule of an input operation; and

dynamically enlarging the one or more touch areas with the higher touch probability of the user; and

determining a touch area touched by the user among the one or more touch areas enlarged within a touch range of the user touch action.

According to the described touch control method, system, and non-transitory computer storage medium, a touch area with a higher or highest clicking probability of the user is found according to an execution manner of the application program interface, then the touch area is enlarged, thus a more accurate touch operation can be accomplished by once touch of the user, thereby reducing user operation steps and saving a step of partial enlargement. Moreover, user experience is improved, and system operation costs are reduced.

### BRIEF DESCRIPTION OF THE DRAWINGS

FIG. 1 is a flow diagram of a touch control input method according to an embodiment;

FIG. 2 is a flow diagram of a touch control input method according to another embodiment;

FIG. 3 is a block diagram of a touch operation system according to an embodiment;

FIG. 4 is a block diagram of a touch operation system according to another embodiment;

FIG. 5 is an interface schematic of a five-in-a-row according to an embodiment;

FIG. 6 is a touch interface schematic of a five-in-a-row according to another embodiment;

FIG. 7 is a schematic of the touch area touched by user shown in FIG. 6; and

FIG. 8 is a schematic of an enlarged touch area of a five-in-a-row according to an embodiment.

### DETAILED DESCRIPTION OF THE EMBODIMENTS

During a use of an application, input operations have certain rules to follow. As an example, when the Chinese character is inputted according to a Pinyin input method, assuming the first letter of P is inputted, the probabilities of the following letters inputted by the user are different from each other, such as the probabilities of letters of Z, W, Y, K, G, T, etc are little, while the probabilities of letters of E, U, I, O and the like are much higher.

As another example, in a use of the web browser, if Uniform Resource Locator (URL) or keywords are inputted, the next buttons touched by the user may be the button for entering the webpage and the button for searching. Such that, the button for entering the webpage and the button for searching can be dynamically enlarged, which facilitates the user to input accurately by once touch.

As another example, in a chess/cards application, the user places stone or shows card following certain rules. According to those rules, a touch area of a favorable position for the stone or the card can be determined, and then the touch area is dynamic enlarged, which facilitates the user to place stone or show card accurately by once input.

Based on the rules of the current application or the normal habits of the user operations, one or more touch buttons with a higher probability touched by the user can be predicted; then the touch areas of those buttons can be dynamically enlarged. Therefore, the desired touch input can be more accurately accomplished by once touch.

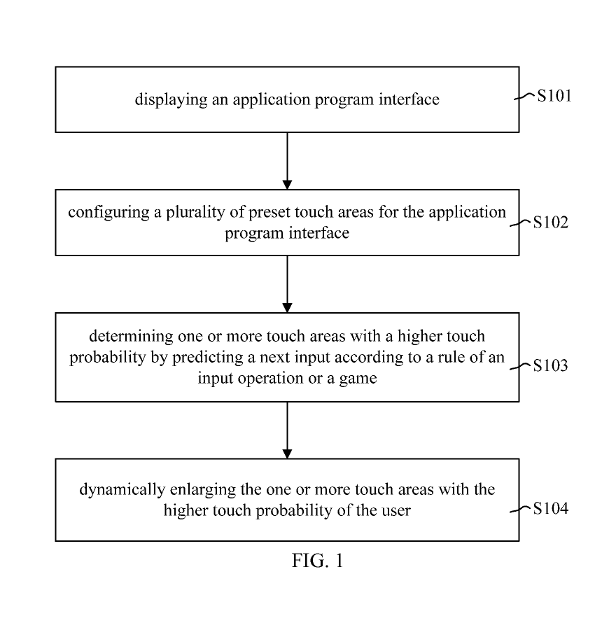

Referring to FIG. 1, which is a flow diagram of an embodiment of a touch control input method, the method includes the steps of:

Step S101, an application program interface is displayed.

Step S102, a plurality of preset touch areas for the application program interface are configured.

Step S103, one or more touch areas with a higher touch probability of a user are determined by predicting a next input after an input according to a rule of an input operation or a game.

Step S104, the one or more touch areas with the higher touch probability of the user are dynamically enlarged.

The dynamically enlarging means that the enlarging is performed before an input; then a default configuration is restored after the input is accomplished.

In the above-described touch control input method, a touch area with a higher or highest clicking probability of the user is found according to an execution manner of the application program interface, then the touch area is enlarged, thus a more accurate touch operation can be accomplished by one touch of the user, thereby reducing user operation steps and omitting a step of partial enlargement. Such that, the operation thereof is convenient, the user experience is improved, and system operation costs are reduced.

In addition, a non-transitory computer storage medium for storing a computer-executable instruction is provided. The computer-executable instruction is configured to execute a touch input method. The touch control input method is described as above, which is not described in detail herein.

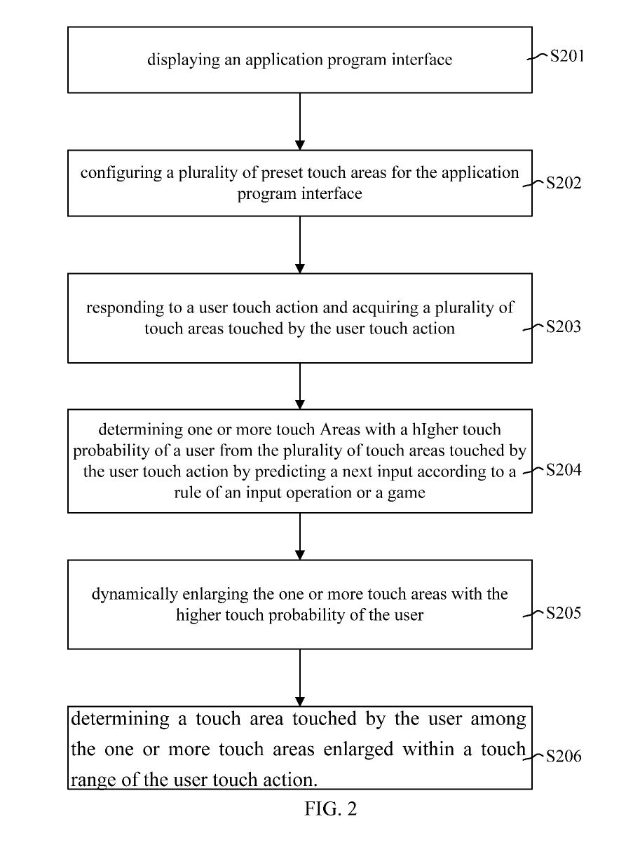

Referring to FIG. 2, which is a flow diagram of another embodiment of a touch control input method, the method includes the steps of:

Step S201, an application program interface is displayed

Step S202, a plurality of preset touch areas for the application program interface are configured.

Step S203, a user touch action is responded and a plurality of touch areas touched by the user touch action are acquired.

Step S204, one or more touch areas with a higher touch probability of the user are determined from the plurality of touch areas touched by the user touch action by predicting a next input after an input according to a rule of an input operation or a game.

Step S205, the one or more touch areas with the higher touch probability of the user are dynamically enlarged.

Step S206, a touch area touched by the user is determined among the one or more touch areas enlarged within a touch range of the user touch action.

The probability of each touch area touched by the user for the next step can be calculated after a first touch operation, which can help the user to find the touch area more pointedly, thus the touch accuracy is improved.

In an embodiment, some of the preset touch areas are close to each other, when one preset touch area is enlarged, it will overlap the adjacent touch area. In order to solve this problem, in an embodiment, the above touch input methods further includes:

An area of a touch area adjacent to the enlarged touch area is shrunk, correspondingly.

A non-transitory computer storage medium for storing a computer-executable instruction is provided. The computer-executable instruction is configured to execute a touch input method. The touch control input method is described as above, which is not described in detail herein.

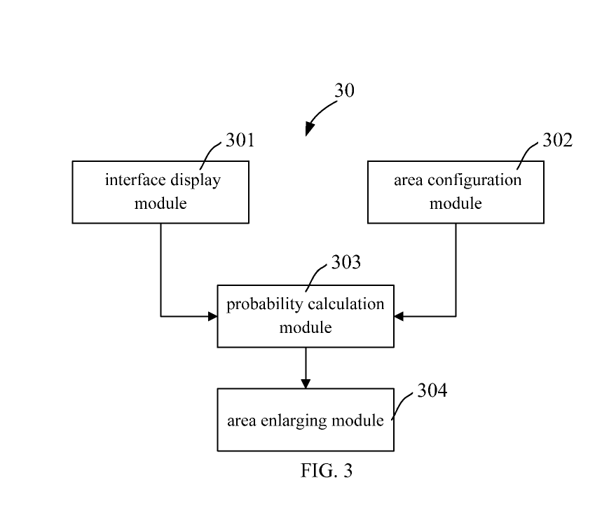

Referring to FIG. 3, which is a functional block diagram of an embodiment of a touch operation system 30. The touch operation system 30 includes an interface display module 301, an area configuration module 302, a probability calculation module 303, and an area enlarging module 304.

The interface display module 301 is configured to display an application program interface.

The area configuration module 302 is configured to configure a plurality of preset touch areas for the application program interface.

The probability calculation module 303 is configured to determine one or more touch areas with a higher touch probability of a user by predicting a next input after an input according to a rule of an input operation or a game.

The area enlarging module 304 is configured to dynamically enlarge the one or more touch areas with the higher touch probability of the user.

The dynamically enlargement means that the enlargement is performed before an input of the user; then a default configuration is restored after the input is accomplished.

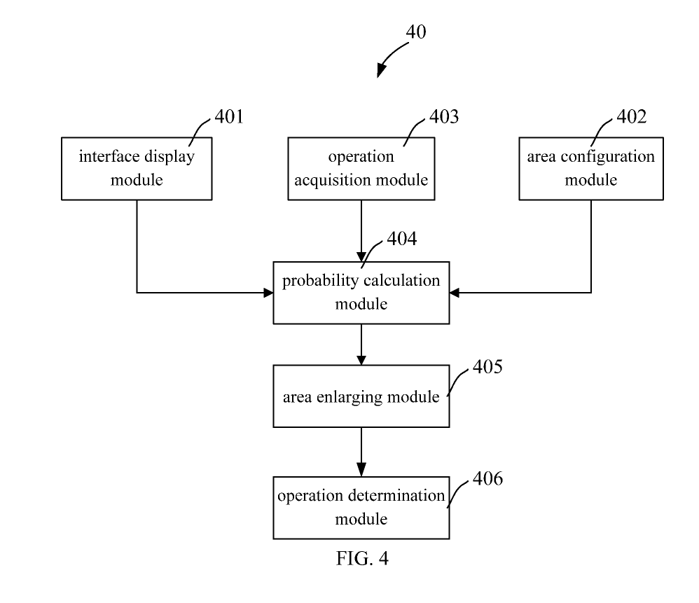

Referring to FIG. 4, which is a functional block diagram of a touch operation system 40 of an embodiment. The touch operation system 40 includes an interface display module 401, an area configuration module 402, an operation acquisition module 403, a probability calculation module 404, an area enlarging module 405, and an operation determination module 406.

The interface display module 401 is configured to display an application program interface.

The area configuration module 402 is configured to configure a plurality of preset touch areas for the application program interface.

The operation acquisition module 403 is configured to respond to a user touch action and acquire a plurality of touch areas touched by the user touch action

The probability calculation module 404 is configured to determine one or more touch areas with a higher touch probability of a user from the plurality of touch areas touched by the user touch action by predicting a next input after an input according to a rule of an input operation or a game.

The area enlarging module 405 is configured to dynamically enlarge the one or more touch areas with the higher touch probability.

The operation determination module 406 is configured to determine a touch area touched by the user according to one or more enlarged touch areas and a touch range of the user touch action.

The probability of each touch area touched by the user for the next step can be calculated after a first touch operation, which can help the user to find the touch area more pointedly, thus the touch accuracy is improved.

In the touch operation systems 30 and 40, a touch area with a higher or highest clicking probability of the user is found according to an execution manner of the application program interface, then the touch area is enlarged, thus a more accurate touch operation can be accomplished by once touch of the user, thereby reducing user operation steps and omitting a step of partial enlargement. Moreover, user experience is improved, and system operation costs are reduced.

The invention will be described in detail by referring to an embodiment of an application of a five-in-a-row.

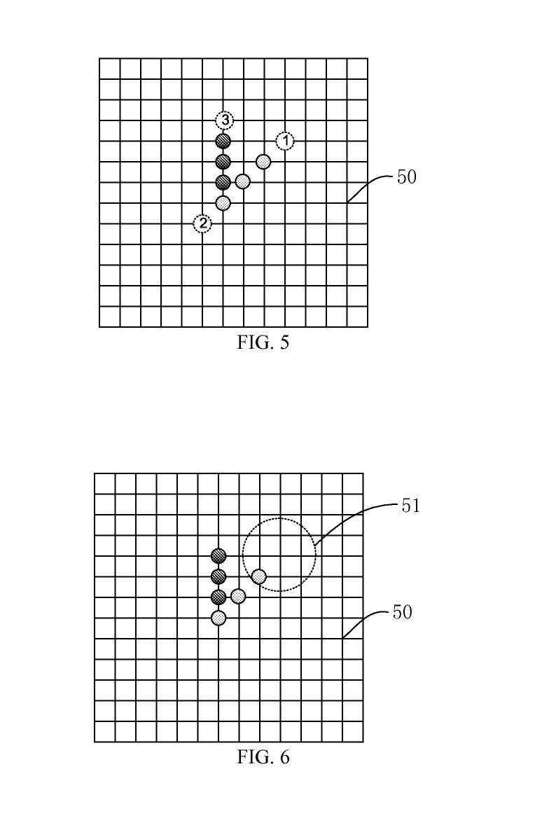

Referring to FIG. 5, in a chessboard grid 50, three black stones and three white stones are placed; now assuming that it is black player's turn to place the stone. According to the game rule, the black stone may more likely be placed on the positions \textcircled{1}, \textcircled{2}, or \textcircled{3}, if the stone is placed on other positions, the black player may probably lose the game. As played with the computer, system can calculate the favorable position according to the game rule. Under a default condition, each touch area for placing the stone is identical. After one or more favorable positions are calculated, at least one touch area of the positions \textcircled{1}, \textcircled{2}, and \textcircled{3} shown in FIG. 5 are dynamically enlarged (while the adjacent touch area can be shrunk, correspondingly), the user can place the stone accurately by once touch.

The dynamic enlarging means that the enlarging is performed in the current placing process, when the stone is placed, each touch area for placing the stone is restored to the default configuration.

In an alternative embodiment, the favorable position can be calculated after the user touches the screen.

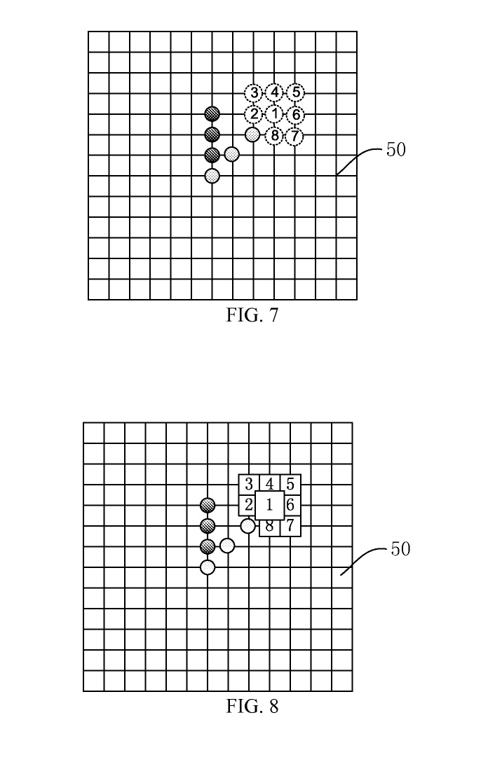

Referring to FIG. 6 to FIG. 8, when the area touched by the user in the chessboard grid 50 is the area arranged inside of the circle 51, which covers positions of \textcircled{1}, \textcircled{2}, \textcircled{3}, \textcircled{4}, \textcircled{5}, \textcircled{6}, \textcircled{7}, and \textcircled{8}. The favorable position in the eight positions can be calculated according to the game rule. In the board grid shown in FIG. 7, it is apparent that position10 is the favorable position; then the touch area of the position \textcircled{1} is enlarged. Accordingly, the user can place the stone accurately by once touch. The enlargement is shown in FIG. 8, where [symbol] represents the enlarged touch area.

The five-in-a-row is just one embodiment of the present disclosure. The described method can be applied to other applications, such as chess, the game of go, poker games and the likes. The favorable positions of the stones or favorable cards can be calculated according to the execution of the application program. One or more touch areas of the favorable positions or card can be enlarged, thus the accurate touch can be performed by once touch; and a step of partial enlargement is omitted.

Although the present invention has been described with reference to the embodiments thereof and the best modes for carrying out the present invention, it is apparent to those skilled in the art that a variety of modifications and changes may be made without departing from the scope of the present invention, which is intended to be defined by the appended claims.

What is claimed is:

1. A touch control input method, comprising:
displaying an application program interface;
configuring a plurality of preset touch areas for the application program interface; determining one or more touch areas with a higher touch probability by predicting a next input after an input according to a rule of an input operation; and
dynamically enlarging the one or more touch areas with the higher touch probability.

2. The touch control input method according to claim 1, wherein the dynamically enlarging comprises:
enlarging before an input; and
restoring a default configuration after completing the input.

3. The touch control input method according to claim 1, wherein the dynamically enlarging comprises:
enlarging before an input; and
recalculating the touch probability for each touch area after completing the input.

4. The touch control input method according to claim 1, further comprising:
shrinking an area of a touch area adjacent to an enlarged touch area, correspondingly.

5. The touch control input method according to claim 1, wherein the determining one or more touch areas with a higher touch probability by predicting a next input after an input according to a rule of an input operation comprises:
responding to a user touch action and acquiring a plurality of touch areas touched by the user touch action;
determining one or more touch areas with a higher touch probability of a user from the plurality of touch areas touched by the user touch action by predicting a next input after an input according to a rule of an input operation;
dynamically enlarging the one or more touch areas with the higher touch probability of the user; and
determining a touch area touched by the user among the one or more touch areas enlarged within a touch range of the user touch action.

6. A touch operation system, comprising one or more processors; and memory having instructions stored thereon, the instructions, when executed by the one or more processors, cause the processors to perform operations comprising:
displaying an application program interface;
configuring a plurality of preset touch areas for the application program interface;
determining one or more touch areas with a higher touch probability by predicting a next input after an input according to a rule of an input operation; and
dynamically enlarging the one or more touch areas with the higher touch probability of the user.

7. The touch operation system according to claim 6, wherein the dynamically enlarging comprises:
enlarging before an input; and
restoring a default configuration after completing the input.

8. The touch operation system according to claim 6, wherein the dynamically enlarging comprises:
enlarging before an input; and
recalculating the touch probability for each touch area after completing the input.

9. The touch operation system according to claim 6, wherein the memory further comprises instructions, which, when executed by the one or more processors, cause the processors to perform operations comprising:
displaying an application program interface;
configuring a plurality of preset touch areas for the application program interface;
responding to a user touch action and acquire a plurality of touch areas touched by the user touch action;
determining one or more touch areas with a higher touch probability of a user from the plurality of touch areas touched by the user touch action by predicting a next input after an input according to a rule of an input operation;
dynamically enlarging the one or more touch areas with the higher touch probability of the user; and
determining a touch area touched by the user among the one or more touch areas enlarged within a touch range of the user touch action.

10. The touch operation system according to claim 9, wherein the dynamically enlarging comprises enlarging before an input.

11. A non-transitory computer storage medium for storing a computer-executable instruction, the computer-executable instruction is configured to execute a touch control input method, wherein the method comprises:
displaying an application program interface;
configuring a plurality of preset touch areas for the application program interface; determining one or more touch areas with a higher touch probability by predicting a next input after an input according to a rule of an input operation; and
dynamically enlarging the one or more touch areas with the higher touch probability.

12. The non-transitory computer storage medium according to claim 11, wherein the dynamically enlarging comprises:
enlarging before an input; and
restoring a default configuration after completing the input.

13. The non-transitory computer storage medium according to claim 11, wherein the dynamically enlarging comprises:
enlarging before an input; and
recalculating the touch probability for each touch area after completing the input.

14. The non-transitory computer storage medium according to claim 11, wherein the method further comprises:
correspondingly shrinking an area of a touch area adjacent to an enlarged touch area.

15. The non-transitory computer storage medium according to claim 11, wherein the determining one or more touch areas with a higher touch probability by predicting a next input after an input according to a rule of an input operation comprises:
responding to a user touch action and acquiring a plurality of touch areas touched by the user touch action;
determining one or more touch areas with a higher touch probability of a user from the plurality of touch areas touched by the user touch action by predicting a next input after an input according to a rule of an input operation; and
dynamically enlarging the one or more touch areas with the higher touch probability of the user; and
determining a touch area touched by the user among the one or more touch areas enlarged within a touch range of the user touch action.
